(19) United States
(12) Patent Application Publication
(10) Pub. No.: US 2007/0204106 A1
(43) Pub. Date: Aug. 30, 2007

(54) Adjusting leakage power of caches

(76) Inventors: James Donald, Princeton, NJ (US); Zhong-Ning George Cai, Lake Oswego, OR (US)

Correspondence Address: Caven & Aghevli LLC;C/O PortfolioIP, P.O. Box 52050, Minneapolis, MN, 55402, US

(21) Appl. No.: 11/361,767

(22) Filed: Feb. 24, 2006

(51) Int. Cl. G06F 12/00

(52) U.S. Cl. 711/118

(57) ABSTRACT

Methods and apparatus to adjust leakage power of a cache are described. In one embodiment, leakage power of a cache is adjusted based on the measured leakage power and a target leakage power value.

### BACKGROUND

The present disclosure generally relates to the field of electronics. More particularly, an embodiment of the invention relates to adjusting leakage power of a cache.

As integrated circuit fabrication technology improves, manufacturers are able to integrate additional functionality onto a single semiconductor die. With the increase in the number of these functionalities, the number of components on a single chip may also increase. Additional components may add additional signal switching, in turn, generating more heat. One such component may be a cache that can be shared by multiple cores present on the same die. As the size of the shared cache is increased (for example, to improve performance), the power consumption of the cache also increases which may generate additional heat. The additional heat may damage a chip by, for example, thermal expansion. Also, the additional heat may limit locations or applications of a computing system that employs such a chip.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 5, and 6 illustrate block diagrams of embodiments of computing systems, which may be utilized to implement various embodiments discussed herein.

FIG. 2 illustrates a block diagram of portions of a shared cache and other components of a processor core, according to an embodiment of the invention.

FIG. 3 illustrates a block diagram of a feedback control system for adjusting the leakage power of a shared cache, according to an embodiment.

FIG. 4 illustrates a block diagram of an embodiment of a method to adjust the leakage power of a shared cache.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention.

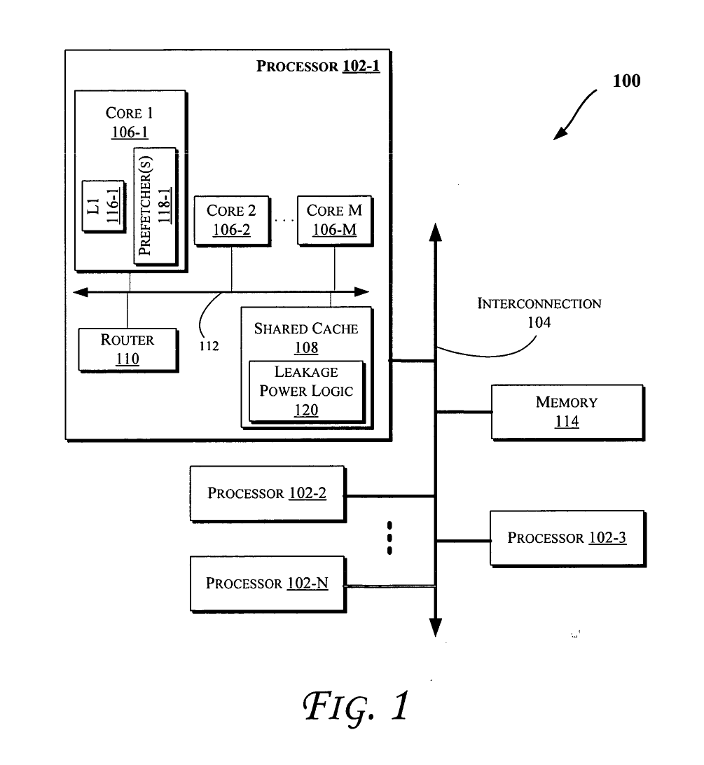

Some of the embodiments discussed herein may enable adjustment of the leakage (or static) power generated by one or more components of a computing system such as a cache (which may be shared in an embodiment). For example, the leakage power may be adjusted dynamically or during runtime of a computing system, such as the computing systems discussed with reference to FIGS. 1 and 5-6. Furthermore, the techniques discussed herein may be used more generally to provide dynamic control over power versus performance of components present in various computing systems, such as the computing systems discussed with reference to FIGS. 1 and 5-6. More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

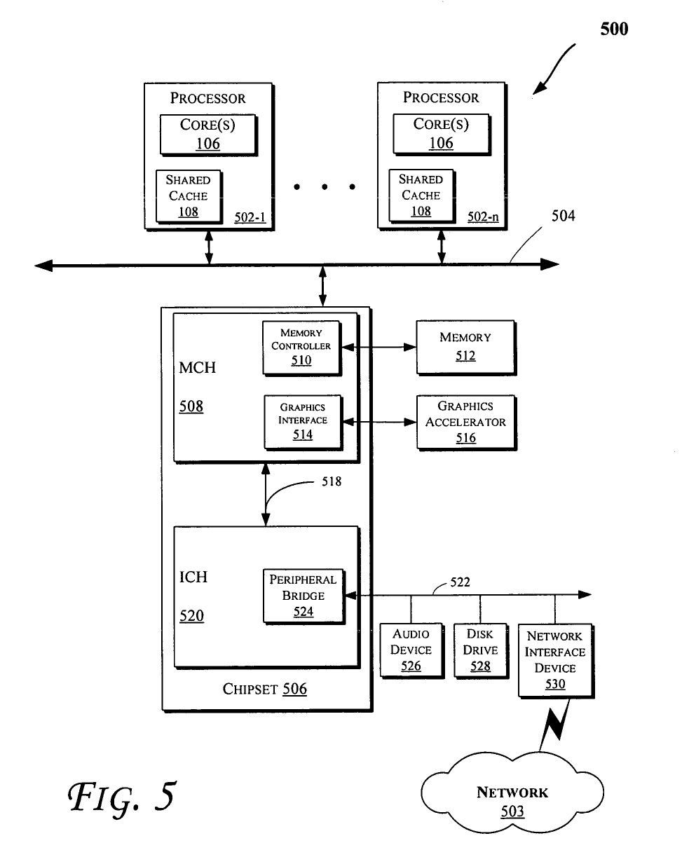

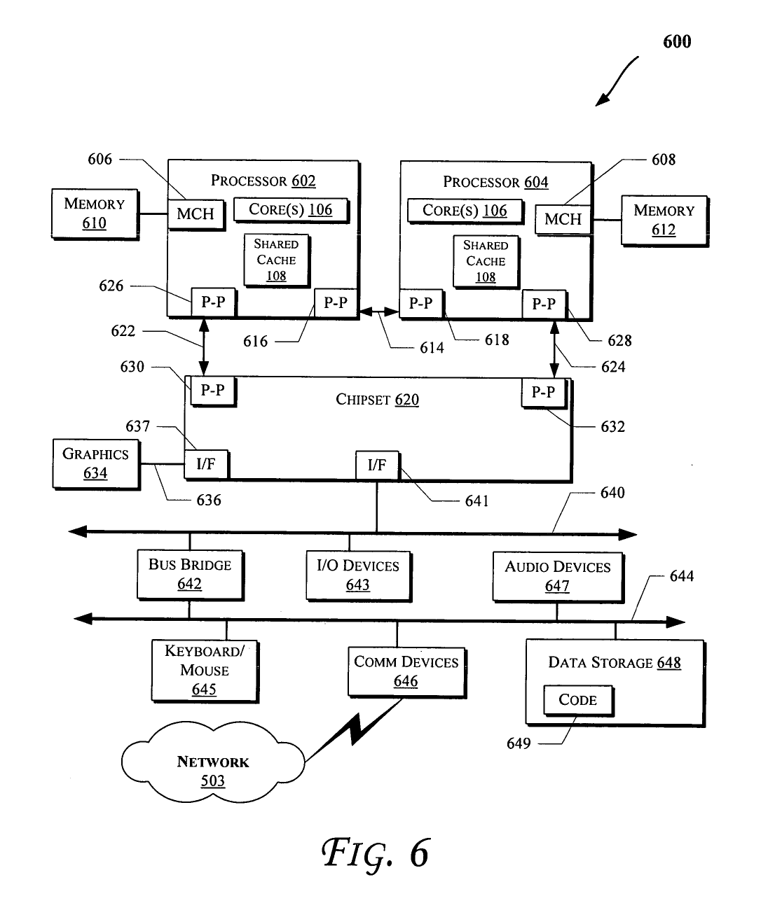

In an embodiment, the processor 102-1 may include one or more processor cores 106-1 through 106-M (referred to herein as “cores 106,” or more generally as “core 106”), a shared cache 108, and/or a router 110. The processor cores 106 may be implemented on a single integrated circuit (IC) chip. Moreover, the chip may include one or more shared and/or private caches (such as cache 108), buses or interconnections (such as a bus or interconnection 112), memory controllers (such as those discussed with reference to FIGS. 5 and 6), or other components.

In one embodiment, the router 110 may be used to communicate between various components of the processor 102-1 and/or system 100. Moreover, the processor 102-1 may include more than one router 110. Furthermore, the multitude of routers (110) may be in communication to enable data routing between various components inside or outside of the processor 102-1.

The shared cache 108 may store data (e.g., including instructions) that are utilized by one or more components of the processor 102-1, such as the cores 106. For example, the shared cache 108 may locally cache data stored in a memory 114 for faster access by components of the processor 102. As shown in FIG. 1, the memory 114 may be in communication with the processors 102 via the interconnection 104. In an embodiment, the cache 108 (that may be shared) may include a mid-level cache (such as a level 2 (L2), a level 3 (L3), a level 4 (L4), or other levels of cache), a last level cache (LLC), and/or combinations thereof.

In some embodiments, one or more of the cores 106 may include a level 1 (L1) cache (116-1) (generally referred to herein as “L1 cache 116”). Various components of the processor 102-1 may communicate with the shared cache 108 directly, through a bus (e.g., the bus 112), and/or a memory controller or hub. In an embodiment, one or more of the cores 106 may also include one or more prefetchers 118-1 (generally referred to herein as “prefetchers 118”), e.g., to speculatively prefetch data into the L1 cache 116 from the memory 114.

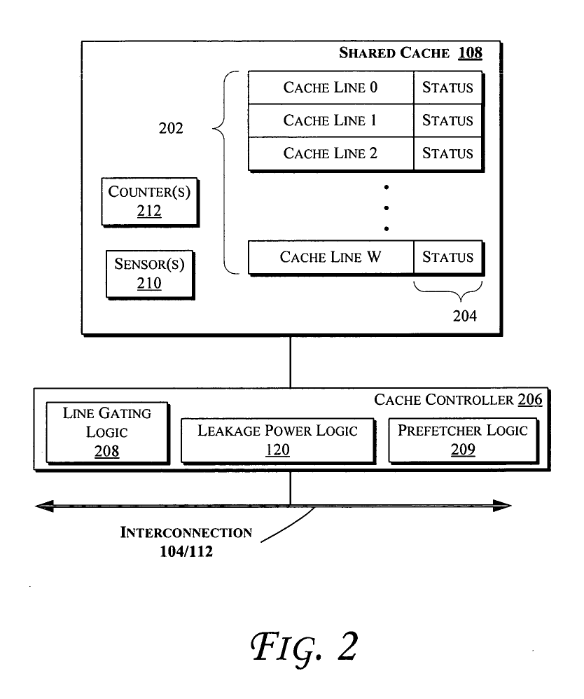

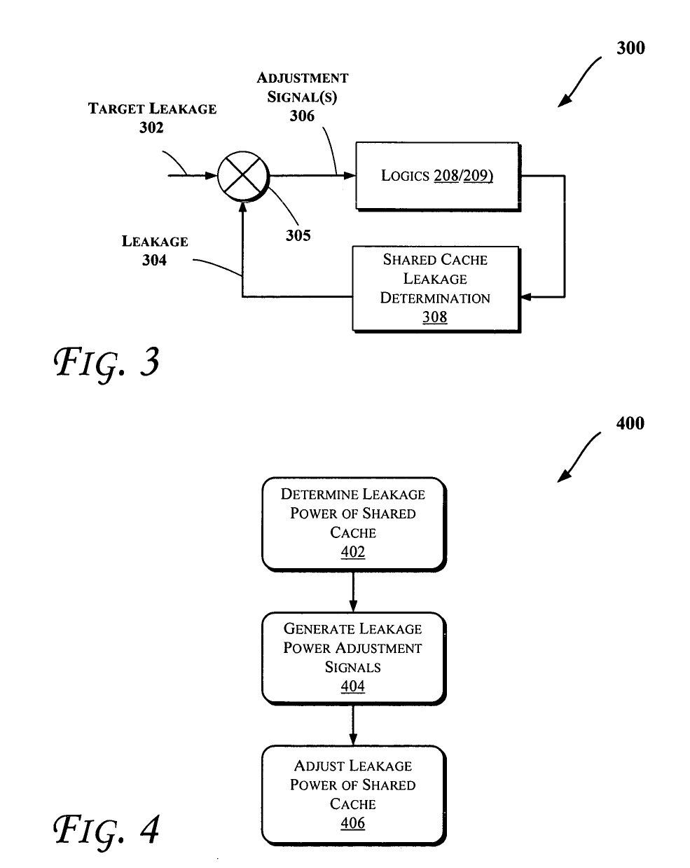

In one embodiment, the shared cache 108 may include a leakage power logic 120, e.g., to determine and/or adjust the leakage power of the shared cache 108 as will be further discussed herein, for example, with reference to FIGS. 2-4. In various embodiments, the operations discussed with reference to the logic 120 herein may be implemented as hardware (e.g., logic circuitry), software, firmware, or combinations thereof. For example, the logic 120 may implement a linear or non-linear feedback system (such as portions of the system 300 of FIG. 3). Examples of a feedback system that may be implemented by the logic 120 may include a proportional integral derivative (PID) system, or other feedback systems that utilize analytical and/or heuristic approaches. For example, a lookup table and/or an arithmetic logic may be utilized to perform the (PID) calculations. Also, the PID algorithm used may be based on a static threshold (e.g., provided by a user or at system startup) or an adaptive threshold (e.g., which is adjusted during runtime). In an embodiment, the PID system may also utilize prevention of reset windup techniques, calculate derivatives or integrals on the output instead of the set point error, and/or linearize discrete input data. Further, even though in FIG. 1, leakage power logic 120 is illustrated inside the shared cache 108, the leakage power logic 120 may be located elsewhere in the system 100.

FIG. 2 illustrates a block diagram of portions of a shared cache 108 and other components of a processor core, according to an embodiment of the invention. As shown in FIG. 2, the shared cache 108 may include one or more cache lines (202). The shared cache 108 may also include one or more status bits (204), e.g., for each of the cache lines (202), as will be further discussed with reference to FIGS. 3 and 4. In one embodiment, a bit (such as the status bits 204) may be utilized to indicate whether the corresponding cache line is active (e.g., non-evicted).

As illustrated in FIG. 2, the shared cache 108 may communicate via one or more of the interconnections 104 and/or 112 discussed with reference to FIG. 1 through a cache controller 206. The cache controller 206 may include logic for various operations performed on the shared cache 108. For example, the cache controller 206 may include line gating logic 208 (e.g., to control which cache lines 202 are turned on or off, or otherwise adjust the level of cache line gating and/or cache line eviction within the shared cache 108) and/or a prefetcher logic 209 (e.g., to control which prefetchers 118 are turned on or off, or otherwise adjust the level of prefetching in the system 100 of FIG. 1, for example). As will be further discussed with reference to FIGS. 3 and 4, the line gating logic 208 and/or prefetcher logic 209 may receive a signal from the leakage power logic 120 to adjust the leakage power of the shared cache 108 dynamically, for example, during runtime.

In one embodiment, one or more sensors 210 (such as temperature or power consumption sensors) may be utilized to measure or determine the leakage power of the shared cache 108, as will be further discussed with reference to FIGS. 3-4. Also, one or more counters 212 may store a value that corresponds to the number of active prefetchers 118 (e.g., that may indicate the level of prefetching employed by the system 100, for example) and/or a value that corresponds to the number of active cache lines 202 (e.g., based on the status bits 204), or more generally a value that corresponds to an active portion of the shared cache 108 (such as the number of active cache banks or active blocks of the shared cache 108). In various embodiments, the value stored in the counters 212 may be updated by counter logic (not shown) or other components such as the cache controller 206, logic 208, logic 209, and/or logic 120. Moreover, the counters 212 may be hardware registers and/or variables stored in a storage device (such as the shared cache 108 and/or the memory 114), in various embodiments. Also, the counters 212 may be provided in other locations than that illustrated in FIG. 2, such as in the cache controller 206, the leakage power logic 120, or elsewhere in the system 100. Further, even though in FIG. 2, the leakage power logic 120 is illustrated inside the cache controller 206, the leakage power logic 120 may be located elsewhere in the system 100 such as discussed with reference to FIG. 1.

FIG. 3 illustrates a block diagram of a feedback control system 300 for adjusting the leakage power of a shared cache, according to an embodiment. In one embodiment, the system 300 may be utilized to adjust the leakage power of the shared cache 108 of FIGS. 1-2.

As shown in FIG. 3, the system 300 may receive a target leakage power signal 302, which may be provided during runtime or set at system initialization. In an embodiment, the target leakage power signal 302 may be generated in accordance with user or system input. For example, the target leakage signal 302 may be reduced when a computing system (e.g., the systems of FIGS. 1 and 5-6) is to operate on battery power only. Alternatively, the target leakage signal 302 may be increased when a computing system (e.g., the systems of FIGS. 1 and 5-6) is to operate in a full power mode, e.g., when plugged into an electrical wall socket. Such an implementation may allow the dynamic adjustment of power consumption by the shared cache 108 during runtime. In one embodiment, the target leakage signal 302 may be generated adaptively in accordance with input from other components such as the logic 120 of FIG. 1 and/or one or more sensors (e.g., sensors 210 of FIG. 2).

As shown in FIG. 3, the target leakage power signal 302 may be combined with a leakage power signal 304 to generate one or more adjustment signals 306. For example, the signals 302 and 304 may be combined such that signal 304 is deducted from the signal 302, e.g., by adding (305) signal 302 to an inverted version of the signal 304. In one embodiment, if the value (e.g., as determined by the amplitude and/or frequency) of signal 304 is equal to the value of signal 302, signal 306 may have the same value as signal 302 and/or 304, e.g., to maintain the same level of leakage power by the shared cache 108. Alternatively, if signal 304 has a lower value than signal 302, the value of signal 306 may be more than the value of signal 302, e.g., to increase the leakage power by the shared cache 108 (for example, by increasing the prefetch level, cache line gating level, and/or cache line eviction level). Otherwise, if signal 304 has a higher value than signal 302, the value of signal 306 may be less than the value of signal 302, e.g., to decrease the leakage power by the shared cache 108 (for example, by decreasing the prefetch level, cache line gating level, and/or cache line eviction level). In an embodiment, the level of signal 306 may be proportionally increased or decreased, e.g., as determined by a factor that respectively indicates the number of levels of increase or decrease in the levels of cache line gating, cache line eviction, and/or prefetch.

As illustrated in FIG. 3, the adjustment signals 306 may be provided to logic that may control the leakage power of the shared cache 108, such as the line gating logic 208 and/or prefetcher logic 209 of FIG. 2 to enable control of the prefetch level and/or cache line gating/eviction level, respectively. The determined shared cache leakage power (308) may be, in turn, utilized to generate the leakage power signal 304. In one embodiment, various portions of the leakage power logic 120 may determine (308) the leakage power of the shared cache 108 and/or generate the leakage signal 304 based on data stored in the counters 212 and/or an output of the sensor(s) 210. Also, the leakage power logic 120 may receive the signal 302 and combine it with the signal 304, e.g., to generate the adjustment signal(s) 306.

FIG. 4 illustrates a block diagram of an embodiment of a method 400 to adjust the leakage power of a shared cache. In an embodiment, various components discussed with reference to FIGS. 1-3, 5, and 6 may be utilized to perform one or more of the operations discussed with reference to FIG. 4. For example, the method 400 may be used to adjust the leakage power of the shared cache 108.

Referring to FIGS. 1-4, at an operation 402, the leakage power logic 120 may determine the leakage power of the shared cache 108, e.g., based on data stored in the counters 212 and/or an output of the sensor(s) 210. In an embodiment, tag camming result reports that indicate which bank of the shared cache 108 has been selected may be used to determine the leakage power of the shared cache 108 at operation 402. The tag camming result reports may be used as a toggling signal to count a banked access rate. For example, the logic 120 may compute the active power plus the leakage power of this bank access rate, e.g., to provide the potential of the power variation in a given bank of the shared cache 108. In one embodiment, tag array hit/miss ratios may be calculated alongside the total number of hits of the shared cache 108 to estimate leakage power of the shared cache 108.

At an operation, 404, the leakage power logic 120 may generate one or more of the adjustment signals 306, e.g., based on the determined leakage power of operation 402 and a previous value of the target leakage power (e.g., via the signal 302). As discussed with reference to FIG. 3, the signals 302 and 304 may be combined to generate the adjustment signal(s) 306 at operation 404. The leakage power of the shared cache is then adjusted (at operation 406) based on the signal(s) 306 that are provided to the line gating logic 208 and/or the prefetcher logic 209, e.g., to adjust or enable control of the prefetch level and/or cache line gating/eviction level, respectively.

FIG. 5 illustrates a block diagram of a computing system 500 in accordance with an embodiment of the invention. The computing system 500 may include one or more central processing unit(s) (CPUs) 502 or processors that communicate via an interconnection network (or bus) 504. The processors 502 may include a general purpose processor, a network processor (that processes data communicated over a computer network 503), or other types of a processor (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors. In an embodiment, one or more of the processors 502 may be the same or similar to the processors 102 of FIG. 1. For example, one or more of the processors 502 may include one or more of the cores 106 and/or shared cache 108. Also, the operations discussed with reference to FIGS. 1-4 may be performed by one or more components of the system 500.

A chipset 506 may also communicate with the interconnection network 504. The chipset 506 may include a memory control hub (MCH) 508. The MCH 508 may include a memory controller 510 that communicates with a memory 512 (which may be the same or similar to the memory 114 of FIG. 1). The memory 512 may store data, including sequences of instructions that are executed by the CPU 502, or any other device included in the computing system 500. In one embodiment of the invention, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple CPUs and/or multiple system memories.

The MCH 508 may also include a graphics interface 514 that communicates with a graphics accelerator 516. In one embodiment of the invention, the graphics interface 514 may communicate with the graphics accelerator 516 via an accelerated graphics port (AGP). In an embodiment of the invention, a display (such as a flat panel display) may communicate with the graphics interface 514 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 518 may allow the MCH 508 and an input/output control hub (ICH) 520 to communicate. The ICH 520 may provide an interface to I/O devices that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the CPU 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with an audio device 526, one or more disk drive(s) 528, and a network interface device 530 (which is in communication with the computer network 503). Other devices may communicate via the bus 522. Also, various components (such as the network interface device 530) may communicate with the MCH 508 in some embodiments of the invention. In addition, the processor 502 and the MCH 508 may be combined to form a single chip. Furthermore, the graphics accelerator 516 may be included within the MCH 508 in other embodiments of the invention.

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 6 illustrates a computing system 600 that is arranged in a point-to-point (PtP) configuration, according to an embodiment of the invention. In particular, FIG. 6 shows a system where processors, memory, and input/output devices are interconnected by a number of point-to-point interfaces. The operations discussed with reference to FIGS. 1-5 may be performed by one or more components of the system 600.

As illustrated in FIG. 6, the system 600 may include several processors, of which only two, processors 602 and 604 are shown for clarity. The processors 602 and 604 may each include a local memory controller hub (MCH) 606 and 608 to enable communication with memories 610 and 612. The memories 610 and/or 612 may store various data such as those discussed with reference to the memory 512 of FIG. 5.

In an embodiment, the processors 602 and 604 may be one of the processors 502 discussed with reference to FIG. 5. The processors 602 and 604 may exchange data via a point-to-point (PtP) interface 614 using PtP interface circuits 616 and 618, respectively. Also, the processors 602 and 604 may each exchange data with a chipset 620 via individual PtP interfaces 622 and 624 using point-to-point interface circuits 626, 628, 630, and 632. The chipset 620 may further exchange data with a high-performance graphics circuit 634 via a high-performance graphics interface 636, e.g., using a PtP interface circuit 637.

At least one embodiment of the invention may be provided within the processors 602 and 604. For example, one or more of the cores 106 and/or shared cache 108 of FIG. 1 may be located within the processors 602 and 604. Other embodiments of the invention, however, may exist in other circuits, logic units, or devices within the system 600 of FIG. 6. Furthermore, other embodiments of the invention may be distributed throughout several circuits, logic units, or devices illustrated in FIG. 6.

The chipset 620 may communicate with a bus 640 using a PtP interface circuit 641. The bus 640 may have one or more devices that communicate with it, such as a bus bridge 642 and I/O devices 643. Via a bus 644, the bus bridge 643 may communicate with other devices such as a keyboard/mouse 645, communication devices 646 (such as modems, network interface devices, or other communication devices that may communicate with the computer network 503), audio I/O device, and/or a data storage device 648. The data storage device 648 may store code 649 that may be executed by the processors 602 and/or 604.

In various embodiments of the invention, the operations discussed herein, e.g., with reference to FIGS. 1-6, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-6.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a first logic to generate a first signal corresponding to leakage power of a cache during runtime; and
a second logic to generate a second signal, based, at least in part, on the first signal and a target leakage power signal, to adjust a level of access to the shared cache.

2. The apparatus of claim 1, further comprising a counter to store a number of active portions of the cache, wherein the first logic generates the first signal based on a value stored in the counter.

3. The apparatus of claim 2, wherein the number of active portions of the cache comprises one or more of: a number of active cache lines of the cache, a number of active cache banks of the cache, or a number of active blocks of the cache.

4. The apparatus of claim 1, further comprising one or more prefetchers to prefetch data into the cache from a memory.

5. The apparatus of claim 4, further comprising a counter to store a number of active ones of the one or more prefetchers, wherein the first logic generates the first signal based on a value stored in the counter.

6. The apparatus of claim 1, wherein the level of access to the cache comprises one or more of a prefetch level, a cache line gating level, or a cache line eviction level.

7. The apparatus of claim 1, further comprising:
a plurality of processor cores to access the cache; and
a prefetcher logic to adjust a level of prefetching by the plurality of processor cores in response to the second signal.

8. The apparatus of claim 1, further comprising a line gating logic to adjust a level of line gating within the cache in response to the second signal.

9. A processor comprising:
one or more processor cores to access data stored in a shared cache;
a logic to generate a first signal based, at least in part, on a second signal corresponding to leakage power of the shared cache and a target leakage power signal.

10. The processor of claim 9, further comprising a plurality of prefetchers to prefetch data from a memory into the shared cache.

11. The processor of claim 10, wherein the first signal causes an adjustment to a number of active ones of the plurality of prefetchers.

12. The processor of claim 9, further comprising one or more sensors, wherein the logic generates the first signal in response to one or more outputs of the one or more sensors.

13. The processor of claim 9, wherein the shared cache comprises a status bit for each cache line.

14. The processor of claim 9, wherein the one or more processor cores and the shared cache are on a same die.

15. The processor of claim 9, wherein the shared cache is one of mid-level cache or a last level cache.

16. A method comprising:
determining a leakage power value corresponding to leakage power of a cache; and
adjusting a leakage power of the cache based on the leakage power value and a previous value of a target leakage power.

17. The method of claim 16, wherein determining the leakage power of the cache comprises determining a number of active prefetchers that speculatively prefetch data from a memory to the cache.

18. The method of claim 16, wherein determining the leakage power of the cache comprises determining a value of leakage power generated by the cache based on an output of one or more sensors.

19. The method of claim 16, wherein determining the leakage power value of the cache comprises determining an active portion of the cache.

20. The method of claim 16, further comprising combining the previous value of the target leakage power and the determined leakage power value to generate at least one leakage power adjustment signal, wherein adjusting the leakage power of the cache is performed in response to the leakage power adjustment signal.

21. The method of claim 16, further comprising modifying the previous value of the target leakage power during runtime.

22. A system comprising:
a memory to store data;
a processor to fetch the data;
a cache to store one or more cache lines that correspond to at least some of the data stored in the memory; and
a logic to estimate leakage power of the cache and to modify a leakage power of the cache.

23. The system of claim 22, wherein the logic estimates the leakage power of the cache based on one or more of:
a number of active cache lines of the cache;
a number of active banks of the cache;
a number of active blocks of the cache; and
a number of active prefetchers that prefetch data from the memory into the cache.

24. The system of claim 22, wherein the logic generates a signal to cause modification of the leakage power of the cache and the system further comprises a line gating logic to adjust a level of line gating within the cache in response to the generated signal.

25. The system of claim 22, further comprising a sensor, wherein the logic generates a signal to cause modification of the leakage power of the cache in response to an output of the sensor.

26. The system of claim 22, further comprising a counter to store a number of active prefetchers that prefetch data from the memory into the cache, wherein the logic generates a signal to cause modification of the leakage power of the cache based on a value stored in the counter.

27. The system of claim 22, further comprising a counter to store a number of active portions of the cache, wherein the logic generates a signal to cause modification of the leakage power of the cache based on a value stored in the counter.

28. The system of claim 22, wherein the cache comprises a status bit for each cache line.

29. The system of claim 22, further comprising a prefetcher logic to adjust a level of prefetching by the plurality of processor cores.

30. The system of claim 22, further comprising an audio device.
